(19) United States
(12) Patent Application Publication
(10) Pub. No.: US 2026/0244606 A1
(43) Pub. Date: Aug. 20, 2026

(54) ADAPTIVE DATASET FILTERING AND PRIORITIZATION

(71) Applicant: Optum Services (Ireland) Limited, Dublin (IE)

(72) Inventors: Conor Brian Breen, Dublin (IE); Kashyap Krishnamurthy, Dublin (IE)

(21) Appl. No.: 19/053,960

(22) Filed: Feb. 14, 2025

(51) Int. Cl. G06F 16/215; G06F 16/21; G06F 16/28

(52) U.S. Cl. CPC G06F 16/215; G06F 16/219; G06F 16/285

(57) ABSTRACT

Various embodiments of the present disclosure provide a data filtering technique that improves the functionality of a computer in various aspects. The technique comprises receiving a set of historical quantiles based on a set of historical datasets; receiving an input dataset for a new time period; determining a quality class for a data subset of the input dataset based on (a) a set of input quantiles for the data subset and (b) the set of historical quantiles; iteratively generating a filtered dataset from the input dataset by: filtering a set of data objects from the data subset based on an initial quantile threshold, determining a dataset volume of the initial filtered dataset failing to meet a volume tolerance, and modifying the target quantile based on the quality class and refiltering the data subset; and providing the filtered dataset to a receiving computing entity.

### BACKGROUND

Data processing systems that manage large volumes of incoming data from multiple sources employ various filtering techniques that balance the data quality with other operational constraints, such as processing speed requirements, among others. Traditional filtering techniques may leverage complex models that may be effective but, due to their complexity, cannot be executed using limited processing resources found in intermediate messaging interfaces. Thus, complex modeling approaches are traditionally performed after data is received, stored, and organized, which leads to the application of redundant processing iterations for data that is ultimately filtered from a received dataset. Alternative approaches, may rely on static rules or thresholds, which may be implemented within intermediate messaging interfaces, but fail to adapt to changing data patterns and quality variations over time. As such, these alternative approaches frequently result in suboptimal data selection, leading to inefficient resource utilization and potential missed opportunities in downstream processes. Moreover, mere stack ranking or simple thresholding may result in bias between different sources or segments of data.

### BRIEF DESCRIPTION OF THE DRAWINGS

FIG. 1 depicts a block diagram of an example architecture in accordance with some embodiments of the present disclosure.

FIG. 2 depicts a block diagram of an example predictive data analysis computing entity in accordance with some embodiments of the present disclosure.

FIG. 3 depicts a block diagram of an example client computing entity in accordance with some embodiments of the present disclosure.

FIG. 4 depicts a dataflow diagram of example hardware and/or software components for filtering datasets in accordance with some embodiments of the present disclosure.

FIG. 5 depicts an operational example of generating nested quantiles in accordance with some embodiments of the present disclosure.

FIG. 6 depicts a dataflow diagram of example hardware and/or software components for generating historical quantiles in accordance with some embodiments of the present disclosure.

FIG. 7 depicts a dataflow diagram of example hardware and/or software components for classifying input quantiles in accordance with some embodiments of the present disclosure.

FIG. 8 depicts a dataflow diagram of example hardware and/or software components for generating a filtered dataset in accordance with some embodiments of the present disclosure.

FIG. 9 depicts a flowchart diagram of an example data filtering process in accordance with some embodiments of the present disclosure.

FIG. 10 depicts a flowchart diagram of an example filtered dataset generation process in accordance with some embodiments of the present disclosure.

### DETAILED DESCRIPTION

Various embodiments of the present disclosure provide dynamic filtering techniques to address technical challenges in data retrieval by automatically adjusting to evolving data characteristics and operational parameters. The quantile-based filtering techniques leverage a set of nested quantiles from a historical dataset as a proxy for determining the data quality of data subsets of an incoming dataset. A nested quantile may comprise a quantile that is a member of a set of quantiles. As such, nested quantiles may be generated at different levels of granularity within a dataset. Using the nested quantiles, an intermediary messaging interface may increase the speed of data quality comparisons by (i) determining input quantiles for each of a set of data subsets of the incoming dataset, (ii) matching the input quantiles to portions of the precomputed set of nested quantiles, and then (iii) determining a quality class of up to each of the data subsets based on their matching nested quantiles. Once determined, the quality classes for up to each of the data subsets may enable iterative data filtering techniques from an incoming dataset to enhance the data quality of a filtered dataset. In this way, a complex historical dataset may be functionally reduced to a data quality lookup table that may adapt to historical quality trends in data while providing the quick retrieval functionality that allows for use within an intermediary messaging interface. By doing so, the dynamic, quantile-based filtering techniques of the present disclosure may improve upon traditional filtering techniques by more effectively balancing data quality with the operational constraints of a filtering system.

According to various embodiments of the present disclosure, the dynamic, quantile-based filtering techniques may leverage a combination of quantiles, filtering features, quality classes, and volume tolerances to extract a filtered dataset from an input dataset with a set of data subsets originating from different external computing entities. For example, the dynamic, quantile-based filtering techniques may compare input quantiles of new data to historical quantiles to dynamically adjust filtering thresholds, on a data subset level, to increase or decrease an amount of data extracted from a particular data subset until a volume parameter is satisfied. In this way, dynamic, quantile-based filtering technique allows for the generation of filtered datasets that meet both quality criteria and volume parameters, optimizing computing resource allocation and ensuring downstream processes receive manageable volumes of high-quality data.

In addition to speed and quality enhancements to data filtering, the dynamic, quantile-based filtering techniques may handle different defined datatypes, including probabilistic, categorical, and/or variable datatypes to assess data quality across any desired data metric. This is accomplished by reducing feature ranges (whether categorical, numerical, undefined, or probabilistic) into comprehensive quantiles that assess their relative distributions rather than the underlying data values. This enables the application of the dynamic, quantile-based filtering techniques to combinations of features within an input dataset without reductions in the performance (e.g., in terms of speed and accuracy) the filtering system. This, in turn, provides a generalized data processing technique that improves the functionality (e.g., in terms of diversity of compatible inputs) of traditional data processing technologies.

In some embodiments, a dynamic, quantile-based filtering techniques are applied in an investigative use case to filter data inventory for downstream analysis. The filtering scheme, for example, may be deployed (e.g., within an intermediary messaging interface) downstream from machine learning models and/or other data prioritization techniques, while being upstream of an inspection/investigation application and/or process. In some embodiments, a nested quantile analysis is used to determine quality classifications of incoming data based on similarities and/or differences between the quantiles of the incoming data and nested historical quantiles reflecting inventory trends over a historical time period. The quality classifications may be determined for each subset of data received from different data sources of incoming data to identify which data sources are providing better quality data at any given time. Using the quality classification scores, different quantile thresholds may be set to iteratively filter incoming data from a data source based on its quality relative to other data sources. In this manner, the dynamic, quantile-based filtering techniques allows for source-based filtering of data for downstream analysis in an environment where the degree of informativeness of each data source may dynamically change in an unpredictable manner over time.

Thus, examples of technologically advantageous embodiments of the present disclosure comprise improved data extraction techniques that enable a distribution of functionality within an intermediary messaging interface to improve data filtering from different data sources in various ways as described herein. Other technical improvements and advantages may be realized by one of ordinary skill in the art.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

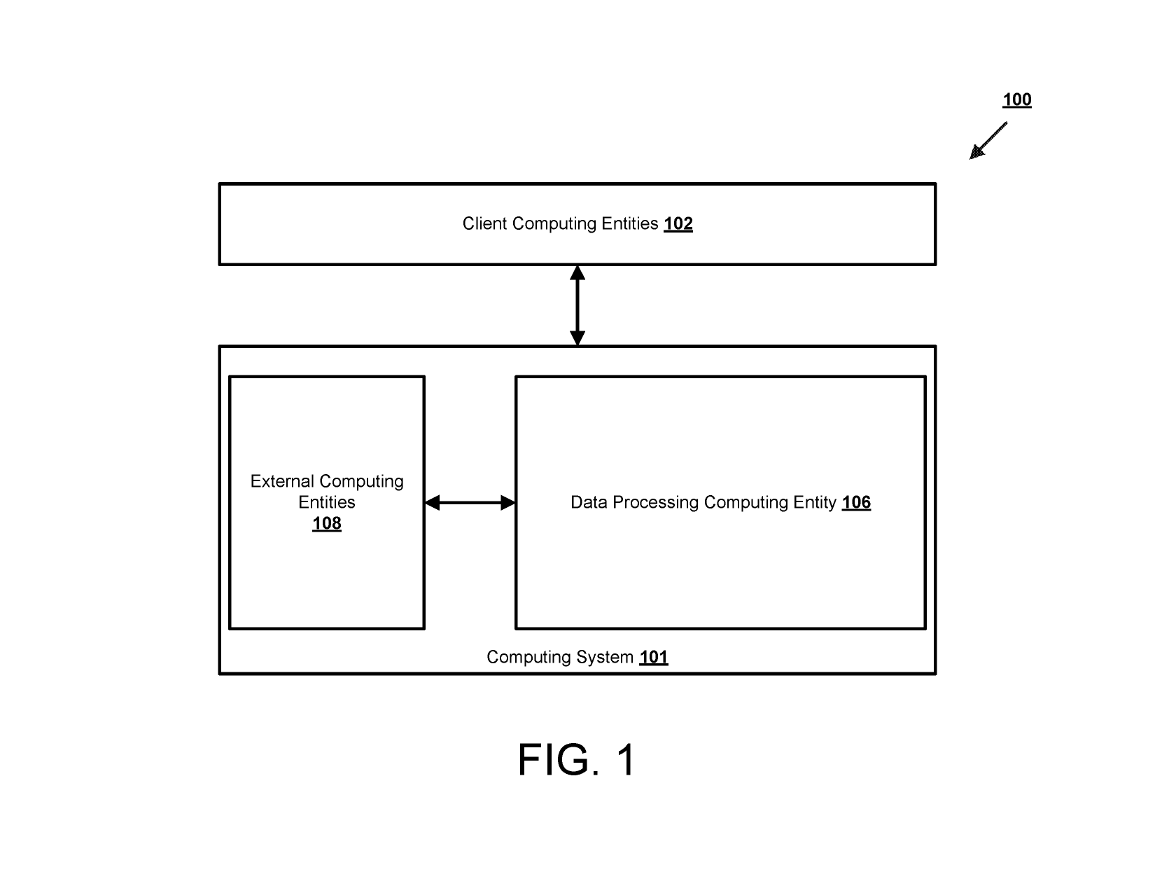

FIG. 1 depicts a block diagram of an example architecture 100 in accordance with some embodiments of the present disclosure. The architecture 100 comprises a computing system 101 configured to receive a request, such as a data filtering request, and/or the like, from client computing entities 102, process the data filtering request, and provide a filtered dataset to the client computing entities 102. The example architecture 100 may be used in a plurality of domains and not limited to any specific application as disclosed herewith. The plurality of domains may comprise healthcare, industrial, manufacturing, computer security, and/or the like to name a few.

In some embodiments, the computing system 101 may communicate with at least one of the client computing entities 102 using one or more communication networks. Examples of communication networks comprise any wired or wireless communication network comprising, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a data processing computing entity 106 and one or more external computing entities 108. The data processing computing entity 106 and/or one or more external computing entities 108 may be individually and/or collectively configured to receive a request, such as a data filtering request, and/or the like, from client computing entities 102, process the data filtering request, and provide a filtered dataset to the client computing entities 102.

In accordance with various embodiments of the present disclosure, one or more machine learning models may be trained to generate candidate outputs, candidate output scores, and/or other machine learned outputs that are provided as datasets for filtering (e.g., as specified by a data filtering request). For example, as discussed in further detail herein, the data processing computing entity 106 and/or one or more external computing entities 108 comprise storage subsystems that may be configured to store input data, historic data, training data, and/or the like that may be used by the respective computing entities to perform predictive data analysis and/or training operations to provide data used by data filtering techniques of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, up to each storage unit in the storage systems may comprise one or more non-volatile storage or volatile storage media similar to or different than the non-volatile and/or volatile computer-readable storage media discussed above.

In some embodiments, the data processing computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the data processing computing entity 106 may be configured to train, implement, use (e.g., execute an inference operation(s)), update (e.g., fine-tune), and evaluate machine learning models in accordance with one or more training and/or inference operations to provide data used by data filtering techniques of the present disclosure. In some examples, the external computing entities 108 may be configured to train, implement, use, update, and evaluate machine learning models in accordance with one or more training and/or inference operations to provide data used by data filtering techniques of the present disclosure.

In some example embodiments, the data processing computing entity 106 may be configured to receive and/or transmit one or more datasets, objects, and/or the like from and/or to the external computing entities 108 to perform one or more steps/operations of one or more techniques (e.g., data filtering techniques, data quality classification techniques, quantile generation techniques) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the data processing computing entity 106 which may leverage the datasets, such as historical datasets and/or input datasets, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the data processing computing entity 106 to obtain and/or aggregate data for an information domain.

In some example embodiments, the data processing computing entity 106 may be configured to receive a trained machine learning model trained and subsequently provided by the one or more external computing entities 108. For example, the one or more external computing entities 108 may be configured to perform one or more training steps/operations to train a machine learning model that provides data used by data filtering techniques of the present disclosure, as described herein. In such a case, the trained machine learning model may be provided to the data processing computing entity 106, which may leverage the trained machine learning model to perform one or more inference steps/operations that provide data used by data filtering techniques of the present disclosure. In some examples, feedback (e.g., evaluation data, ground truth data) from the use of the machine learning model may be received and/or stored by the data processing computing entity 106. In some examples, the feedback may be provided to the one or more external computing entities 108 to continuously train the machine learning model over time. In some examples, the feedback may be leveraged by the data processing computing entity 106 to continuously train the machine learning model over time. In this manner, the computing system 101 may perform, via one or more combinations of computing entities, one or more prediction, training, and/or any other machine learning-based techniques used by data filtering techniques of the present disclosure.

### A. Example Computing Entity

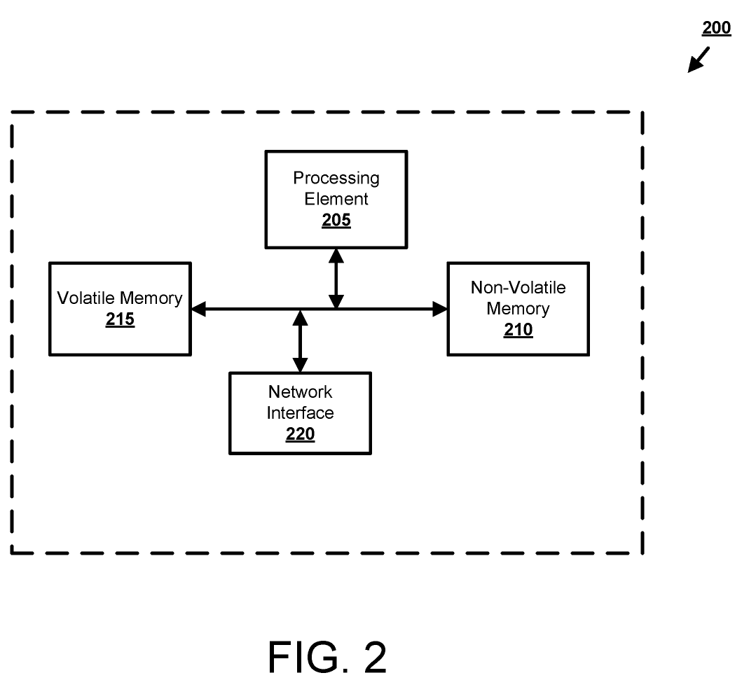

FIG. 2 depicts a block diagram of an example computing entity 200 in accordance with some embodiments of the present disclosure. The computing entity 200 is an example of the data processing computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., data processing computing entity 106) may train and use one or more machine learning models described herein. In other embodiments, a first computing entity (e.g., data processing computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), quantum memory (e.g., solid quantum memory, atomic gas quantum memory), and/or the like..

In some embodiments, non-volatile memory 210 may comprise a computer-readable storage medium that may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium comprising random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (comprising various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilizes quantum bits, or qubits, which may exist in multiple states simultaneously through a property called superposition. Unlike classical bits that may only be in a state of 0 or 1, qubits may represent both states at once, allowing for exponentially greater quantities of information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, comprising as computer program products that comprise articles of manufacture. Such computer program products may comprise one or more software components comprising, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (comprising volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

In some embodiments, one or more components of the present disclosure may be implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computer entity 200 may be specialized for machine learning tasks. By way of example, large language models (LLMs) and other transformer networks may be specially designed for operation within a quantum environment by replacing weight matrices in self-attention and/or multi-layer perceptron layers of such models with one or more combinations of variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures used to provide data for the data filtering techniques of the present disclosure may be configured for classical computer or quantum computers based on the embodiment.

As indicated, in some embodiments, the computing entity 200 may also comprise one or more network interfaces 220 for communicating with various computing entities (e.g., the client computing entities 102, external computing entities 108), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

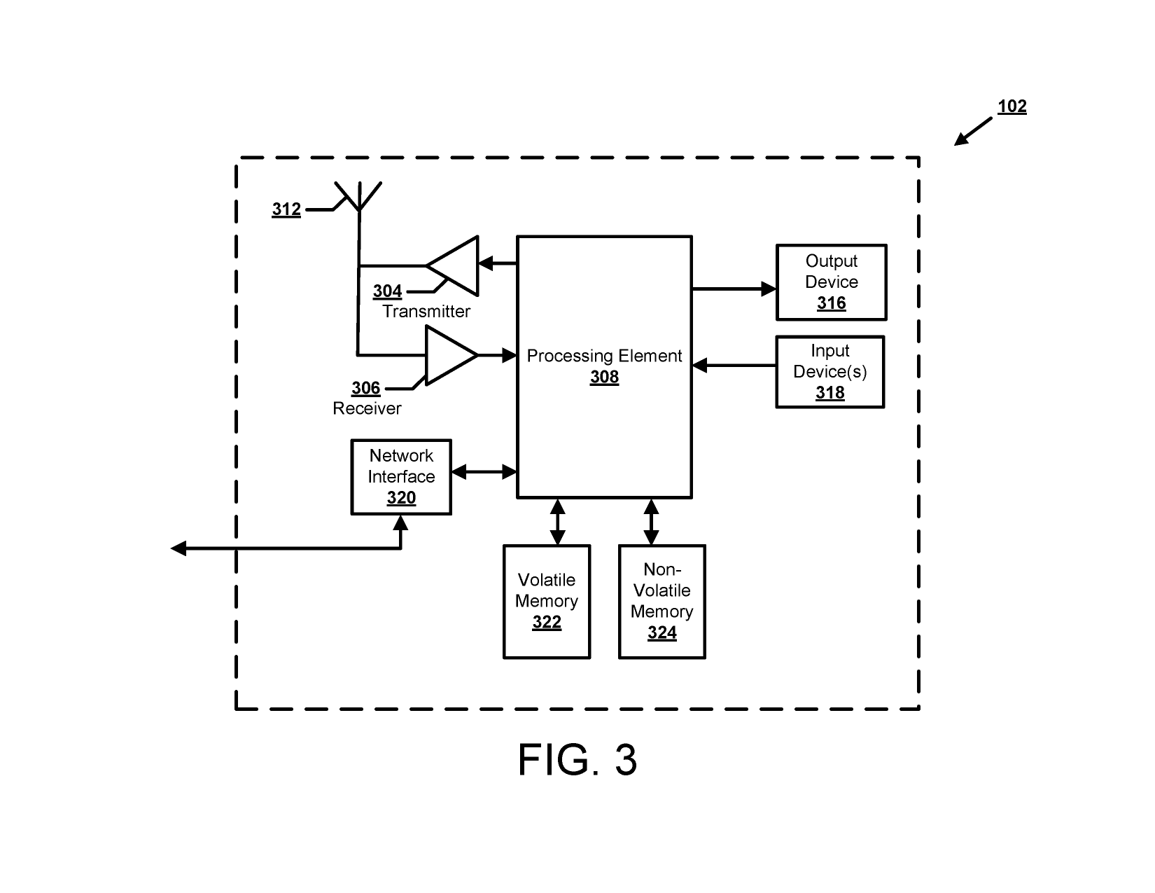

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., comprising executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, comprising Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, comprising cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies comprising RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the data processing computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

As indicated, various embodiments of the present disclosure make important technical contributions to adaptive data processing. In particular, systems and methods are disclosed herein that implement a combination of data filtering techniques, data quality classification techniques, and quantile generation techniques to improve task prioritization, resource allocation, and efficiency of downstream operations in resource-constrained computing environments. By doing so, the data filtering techniques, data quality classification techniques, and quantile generation techniques of the present disclosure enable improved data storage and retrieval processes that, when executed on a computer, improves computing resource allocation. This, in turn, may improve the functionality of a computer with respect to various computing tasks, comprising data security, machine learning training, network communication, and/or the like.

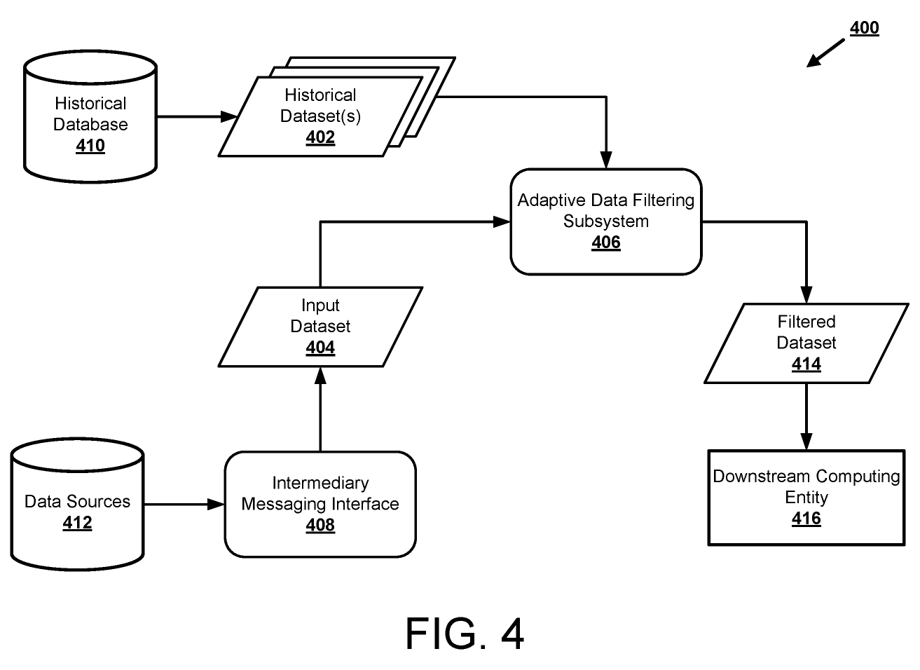

FIG. 4 depicts a dataflow diagram 400 of example hardware and/or software components for filtering datasets in accordance with some embodiments of the present disclosure. The dataflow diagram 400, for example, illustrates a data processing system architecture that is configured to provide data filtering of incoming data streams from data sources 412. An intermediary messaging interface 408 is configured to receive data from data sources 412. The intermediary messaging interface 408 is communicatively coupled to an adaptive data filtering subsystem 406 in a manner that allows the intermediary messaging interface 408 to provide the received data to an adaptive data filtering subsystem 406 as an input dataset 404. The adaptive data filtering subsystem 406 is communicatively coupled with a historical database 410 such that one or more historical datasets 402 may be provided to and/or accessed by the adaptive data filtering subsystem 406.

The adaptive data filtering subsystem 406 is configured to generate a filtered dataset 414 from the input dataset 404. The adaptive data filtering subsystem 406 may determine one or more filtering features of the input dataset 404 and generate input quantiles for the input dataset 404 based on the one or more filtering features of the input dataset 404. Similarly, the adaptive data filtering subsystem 406 may determine one or more filtering features of the one or more historical datasets 402 and generate historical quantiles for the one or more historical datasets 402 based on the one or more filtering features of the one or more historical datasets 402. The input quantiles may be compared with the historical quantiles by the adaptive data filtering subsystem 406 to determine a quality class for a data subset of the input dataset 404. The adaptive data filtering subsystem 406 may generate the filtered dataset 414 with a dataset volume that satisfies a volume tolerance by varying a target quantile of a quantile threshold based on the quality class. In this way, the data processing system architecture may provide a dynamic, quantile-based filtering technique that adapts to evolving data characteristics and operational parameters.

In some embodiments, a set of historical quantiles is generated based on a set of the one or more historical datasets 402 for a historical time period, wherein a historical quantile of the set of historical quantiles comprises a range of values that is associated with a filtering feature. In some embodiments, the input dataset 404 for a new time period subsequent to the historical time period is received, wherein the input dataset 404 comprises a set of data subsets respectively received from a set of different data sources 412. For example, the input dataset 404 is received, from the set of different data sources 412, at the intermediary messaging interface 408. The intermediary messaging interface 408 may be configured to (i) aggregate the set of data subsets into the input dataset 404, (ii) provide the input dataset 404 to the adaptive data filtering subsystem, and (iii) provide the filtered dataset 414 to the downstream computing entity 416.

In some embodiments, a quality class is determined for a data subset of the set of data subsets based on similarities and/or differences between (a) a set of input quantiles for the data subset and (b) the set of historical quantiles. For example, the set of historical quantiles are divided into a set of quality classes and the quality class for the data subset is determined from the set of quality classes based on a matching historical quantile from the set of historical quantiles. In some embodiments, the filtered dataset 414 is iteratively generated from the input dataset 404 by (i) filtering a set of data objects from the data subset based on an initial quantile threshold that corresponds to a target quantile of the set of input quantiles to generate an initial filtered dataset, (ii) determining a dataset volume of the initial filtered dataset, and (iii) responsive to the dataset volume failing to meet a volume tolerance, modifying the target quantile based on the quality class and refiltering the data subset. For example, modifying the target quantile comprises, in response to (i) the dataset volume exceeding the volume tolerance and (ii) the quality class exceeding a quality threshold, increasing the target quantile to a quantile subsequent to the initial quantile threshold. As another example, modifying the target quantile based on the quality class comprises, in response to (i) the dataset volume failing to meet the volume tolerance and (ii) the quality class failing to meet a quality threshold, decreasing the target quantile to a quantile preceding the initial quantile threshold.

In some embodiments, the filtered dataset 414 is provided to a receiving computing entity, such as downstream computing entity 416. In some embodiments, the input dataset 404 is stored (e.g., after generating the filtered dataset 414 from the input dataset 404) in the historical database 410 and comprised in the one or more historical datasets 402 such that the set of historical quantiles is regenerated based on the input dataset 404.

In some embodiments, a quantile describes a portion of a distribution that defines a range of values from the distribution. A quantile may represent a specific value of a plurality of specific values from data objects of a dataset that divide the dataset into data subsets. For example, quartiles may divide a dataset into four equal parts. In some embodiments, quantiles are utilized to analyze historical data trends and/or assess the quality of new data by comparing the new data to historical quantiles. Quantiles may provide a basis for data quality assessment, data volume threshold setting, and/or data inventory filtering. By comparing new data to historical quantiles, a data processing system may dynamically adjust its processing parameters to optimize data inventory management.

In some embodiments, a historical quantile describes a quantile of a set of historical datasets. For example, historical quantiles may be determined for data collected over a specified period in the past. Historical quantiles may provide a benchmark for comparison with quantiles of new data. That is, historical quantiles may capture distribution characteristics of historical data, allowing for trend analysis and/or anomaly detection for incoming data streams.

In some embodiments, a historical quantile comprises a reference point for assessing the quality of new data. By comparing incoming data against historical quantiles, a system may determine whether new data falls within expected ranges or represents a significant deviation from historical patterns. For example, historical quantiles may be used to establish dynamic thresholds for data filtering, guide an adjustment of processing parameters, and/or inform machine learning models about long-term data trends.

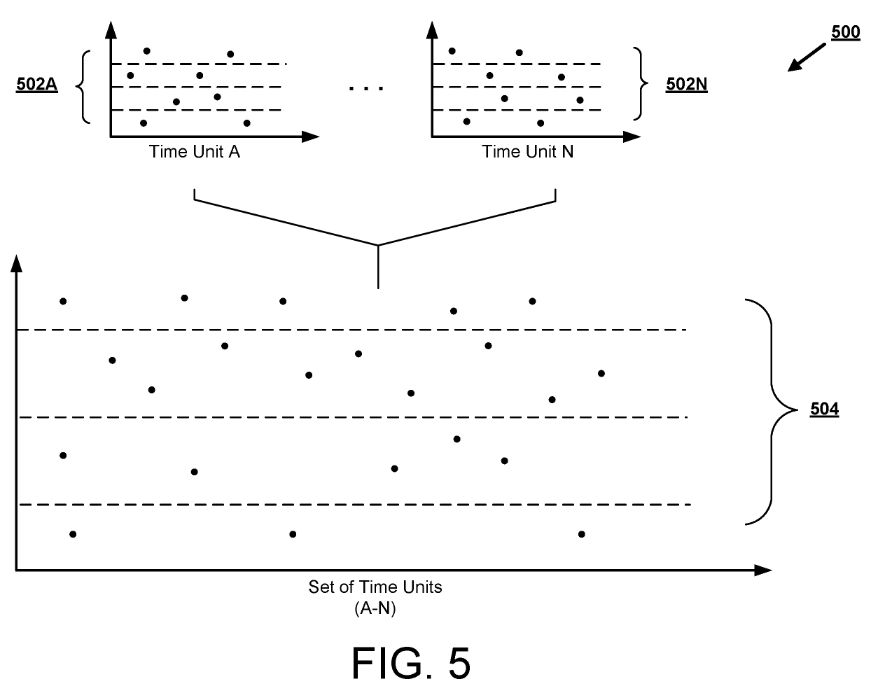

In some embodiments, a historical quantile comprises a nested quantile that is associated with a portion of a historical dataset that respectively corresponds to a specific level of granularity (e.g., time units). As such, sets of quantiles may be generated at different levels of granularity for a historical dataset and analyzed accordingly. Generating nested quantiles are described in further detail with respect to the description of FIG. 5.

In some embodiments, a filtering feature describes a data feature that is used to determine the distribution from which quantiles are taken. In some embodiments, a filtering feature is associated with a specific attribute or characteristic of a data object that is used as a criterion for organizing, analyzing, or filtering a dataset. As such, a filtering feature may serve as a parameter in a process of generating quantiles and subsequently filtering data based on the quantiles. Thus, a selection of appropriate filtering features may determine the effectiveness of a quantile-based dataset filtering process.

A filtering feature may be numeric (e.g., transaction amounts, time durations), categorical (e.g., product categories, customer segments), or derived based on more complex data types (e.g., text sentiment scores, geospatial coordinates). In some embodiments, a filtering feature is derived from unstructured data (e.g., text or images) by using machine learning models or natural language processing techniques to extract and/or quantify features relevant for filtering (e.g., as filtering features). In some embodiments, filtering features are used to generate quantiles that capture the distribution of specific data characteristics. The generated quantiles may then serve as thresholds for filtering incoming data. In some embodiments, a system may dynamically select or prioritize filtering features based on effectiveness of the filtering features in distinguishing high-quality data objects from low-quality data objects.

In some embodiments, a quality class describes a classification or identification of a grouping that is assigned to a data subset based on a quantile in which the data subset belongs. For example, higher quantiles may be associated with quality classes that are higher (e.g., better, more desirable, and/or more suitable). In some embodiments, a quality class is associated with a grouping that corresponds to a specific historical quantile. As such, quality classes may be used to provide a categorical assessment of new data quality by grouping data subsets of new data into predefined categories based on their similarity to historical quantiles. Accordingly, a quality class may enable efficient decision-making processes in data management and/or processing pipelines.

In some embodiments, quality classes are defined based on a set of rules and/or thresholds that map quantile ranges to specific quality classes. For example, quantile ranges that are associated with a plurality of historical quantiles are mapped to respectively corresponding quality classes. Such rules and/or thresholds may be stored in a configuration file and/or database and may be dynamically updated based on changing operational parameters and/or data patterns/trends. In some embodiments, quality classes are assigned to data subsets of new data based on a classification algorithm that is used to (i) perform comparisons of input quantiles of the data subsets to historical quantiles, (ii) determine matches of the input quantiles to a plurality of historical quantiles based on the comparisons, wherein the plurality of historical quantiles are associated with a respectively corresponding plurality of quality classes, and (iii) determines quality classes for the data subsets based on the matches.

Quality classes may provide a simplified representation of data quality that is interpretable and actionable upon by downstream processes. For example, an adaptive algorithm’s decision-making process may be configured to identify data subsets that are assigned to higher quality classes may be prioritized for processing or may be subject to less stringent filtering criteria. Thus, the functionality of quality classes may extend beyond simple categorization and may be used to trigger specific actions or workflows, adjust processing parameters, or inform resource allocation decisions.

In some embodiments, an input quantile describes a quantile of an input dataset. For example, input quantiles may be determined for newly received data (e.g., as new data is ingested into a system) and represent the distribution characteristics of a current data stream. In some embodiments, input quantiles are compared with historical quantiles to assess the quality of new data. Such comparison may form a basis for assigning quality classes and performing data filtering and/or prioritization of the new data.

In some embodiments, a filtered dataset describes a subset of an input dataset that satisfies a volume tolerance. The generation of a filtered dataset may comprise applying filtering criteria based on quantile thresholds or other quality metrics to the input dataset. In some embodiments, a data volume of a resulting filtered dataset may be checked against predefined tolerance levels. For example, if the data volume of an initial filtered dataset falls outside an acceptable range, a filtering criteria used to generated the initial filtered dataset may be adjusted iteratively until a data volume tolerance is met.

In some embodiments, generating a filtered dataset from an input dataset comprises (i) applying a quantile threshold criterion (e.g., that corresponds to a target quantile) to the input dataset and (ii) determining that the filtered dataset meets a specified volume tolerance (e.g., within a data volume range, or greater than and/or less than a specific volume of data). As such, a filtered dataset that meets a quality criteria (via the quantile threshold) as well as a data volume tolerance may be generated from an input dataset.

In some embodiments, filtered datasets are generated to manage data inventory for downstream processes. That is, a dataset filtering process may ensure that high-quality data meeting specific criteria is passed on for further processing or investigation. The volume tolerance aspect may provide an additional layer of control, allowing a data processing system to balance data quality with operational capacity constraints. In some embodiments, filtered datasets are used to focus computational resources on the most promising subsets of data, or used to select optimal subsets of data for targeted analysis. Thus, the functionality of filtered datasets extends beyond mere data reduction and may serve as a mechanism for optimizing resource allocation, ensuring that downstream processes receive a manageable volume of high-quality data.

In some embodiments, a quantile threshold describes a criterion that corresponds to a target quantile for filtering data objects from a data subset. For example, a quantile threshold may comprise a specific value derived from a quantile distribution of a dataset that serves as a cutoff point for comprising and/or excluding data objects to generate a filtered dataset. As such, a quantile threshold may provide a statistical basis for data filtering based on the characteristics of a quantile distribution. A quantile threshold may comprise a numerical value that is compared against a set of quantiles assigned to data objects of a data subset.

In some embodiments, quantile thresholds are used by an adaptive algorithm to filter data inventory based on data quality assessments. For example, a system may maintain a plurality of quantile thresholds corresponding to different quality classes. Quantile thresholds may also be dynamically adjusted based on similarities and/or differences between input quantiles and historical quantiles, thereby allowing a system to adapt to changing data patterns and maintain optimal filtering performance. Accordingly, quantile thresholds may enable data-driven, adaptive dataset filtering processes that automatically adjust to variations in data quality and distribution. By using quantile thresholds, a system may maintain consistent data quality standards even as underlying data characteristics change over time.

In some embodiments, a target quantile describes a desired quantile for setting as a quantile threshold. That is, a target quantile may represent a specific point in a quantile distribution that is used as a filtering criterion. A target quantile may serve as a goal or reference point for adjusting quantile thresholds to achieve desired filtering outcomes. The selection and/or adjustment of a target quantile may be based on a combination of statistical analysis and business logic. Machine learning models and/or optimization algorithms may be employed to determine optimal target quantiles based on historical performance data (e.g., based on historical quantiles) and current system objectives. A target quantile may be adjusted to balance multiple objectives in a dataset filtering process, such as maintaining data quality while achieving data volume goals. For example, by adjusting target quantiles, a system may fine-tune dataset filtering to adapt to changing priorities or operational constraints. In some embodiments, a target quantile may be used in load balancing systems to guide task distribution.

In some embodiments, a dataset volume describes a quantity of data objects within a dataset. For example, dataset volume may comprise a measure of the size or extent of a dataset in terms of a quantity of data points, values, objects, or any other metric that may affect an amount of computing resources used for processing the dataset. In some embodiments, a dataset volume of a filtered dataset is monitored to ensure that the filtered dataset meets a specified volume tolerance level. If the dataset volume of the filtered dataset is too high or too low, a filtering criteria used to generate the filtered dataset may be adjusted to increase or decrease the dataset volume to within the volume tolerance level. As such, a data volume-based feedback loop may be provided to maintain a balance between data quality and/or operational capacity constraints. Moreover, dataset volume may provide a parameter for facilitating resource allocation decisions, performance optimization, and/or workload management. By monitoring and controlling dataset volumes (e.g., of a filtered dataset), a system may ensure efficient utilization of computational resources and maintain consistent processing times.

In some embodiments, a volume tolerance describes a critical dataset volume (or quantity of data objects) that is allowed for a dataset. For example, volume tolerance may define an acceptable range or limit for a number of data objects in a filtered dataset, which may be specified as a minimum and/or maximum value or as a target value with an allowed deviation. Thus, volume tolerance may comprise a constraint in data processing pipelines to ensure that downstream processes receive a manageable and consistent volume of data. In some embodiments, volume tolerance comprises one or more threshold values and comparison logic. The one or more threshold values may be stored in configuration files and/or databases and may be dynamically adjusted based on system capacity or operational parameters. In some embodiments, a dataset volume of a filtered dataset is monitored against a volume tolerance, and responsive to the dataset volume failing to meet the volume tolerance, a target quantile of a quantile threshold used to filter a data subset and generate the filtered dataset, is modified to refilter the data subset.

In some embodiments, volume tolerance is used by an adaptive algorithm to determine whether current data filtering settings are producing an appropriate volume of high-quality data. For example, when a data volume of a filtered dataset exceeds or falls short of a volume tolerance, an iterative process may be initiated to adjust filtering (e.g., quantile) thresholds, to adjust the data volume of the filtered dataset to within a specified and/or optimized range while maintaining data quality standards. As such, volume tolerance may be used to provide adaptive data processing (e.g., data filtering) pipelines that may automatically adjust to variations in input data volume and quality. By enforcing volume tolerances, downstream bottlenecks may be prevent, consistent processing times may be ensured, and resource utilization may be optimized.

In some embodiments, an intermediary messaging interface describes an interface that is configured to (i) aggregate a plurality of datasets from a plurality of data sources, wherein the plurality of datasets is provided for generating a filtered dataset and (ii) provide the filtered dataset to a receiving computing entity. In some embodiments, an intermediary messaging interface is configured as a centralized communication hub that collects data from multiple data sources, processes the data according to specified criteria, and distributes a resulting filtered data to downstream systems or applications. An intermediary messaging interface may comprise a combination of message queuing systems, data transformation logic, and/or application programming interface (API) endpoints. In some embodiments, an intermediary messaging interface may use technologies, such as Apache Kafka, RabbitMQ, or cloud-based services, such as Amazon Simple Queue Service (SQS), to handle high-volume, real-time data ingestion from multiple data sources. In some embodiments, an intermediary messaging interface may employ data serialization formats, such as JSON and/or Protocol Buffers, to provide efficient data transfer and parsing.

An intermediary messaging interface may be configured to centralize data flow for an adaptive dataset filtering process. For example, an intermediary messaging interface may be configured to aggregate data from various sources, potentially in different formats or with different update frequencies, and provide a unified stream of data for performing dataset filtering. Generated filtered dataset may then be routed by the intermediary messaging interface to appropriate receiving entities, which may comprise investigation applications/systems, auditing systems, and/or other downstream processes. In some embodiments, an intermediary messaging interface is configured to perform data validation, format conversion, and preliminary filtering of data to ensure that relevant and/or properly formatted data enters a main data filtering pipeline. An intermediary messaging interface may also be configured to implement retry logic, error handling, and/or monitoring capabilities to ensure reliable data transfer.

FIG. 5 depicts an operational example 500 of generating nested quantiles in accordance with some embodiments of the present disclosure. As shown in the operational example 500, individual first sets of quantiles 502A through 502N are generated from data subsets of an input dataset that respectively correspond to individual time units A through N. That is, the first set of quantiles 502A respectively corresponds to a data subset of the input data for a time unit A, and continues so forth where the first set of quantiles 502N respectively corresponds to a data subset of the input data for a time unit N.

A second set of quantiles 504 is generated based on an aggregate of the plurality of first sets of quantiles 502A through 502N. For example, the second set of quantiles 504 respectively corresponds to an entirety of the input dataset which comprises the data subsets that are associated with a set of time units (e.g., a historical time period) comprising time units A through N. Accordingly, the first sets of quantiles (e.g., any of 502A through 502N) may be aggregated into the second set of quantiles 504 across the set of time units to generate a set of nested quantiles. In this way, nested quantiles may capture distribution characteristics of historical data over different levels of granularity, allowing for improved trend analysis and/or anomaly detection for incoming data streams.

In some embodiments, a historical time period comprises a set of time units, and the set of historical quantiles comprises a set of nested quantiles that is generated by (i) generating a first set of quantiles for a time unit of the set of time units within the historical time period and (ii) aggregating the first set of quantiles into a second set of quantiles across the set of time units within the historical time period to generate the set of nested quantiles. For example, a historical time period may comprise a set of 90 days, where four quantiles are determined and/or generated for each of the 90 days in the history. Then, each of the four quantiles may be aggregated into four further quantiles across all the days of the historical time period to generate a set of sixteen nested quantiles.

In some embodiments, a time unit describes an interval of time that is used to measure or represent duration. For example, a time unit may comprise one or more of seconds, minutes, hours, days, weeks, months, or years. A time unit may comprise a standardized measure of time for defining quantile granularity. In some embodiments, a historical time period comprises a set of time units, wherein a set of historical quantiles associated with a set of historical datasets for the historical time period is generated for the set of time units. As an example, a time unit may comprise a day and the set of time units may comprise a plurality of days. In some embodiments, the set of historical quantiles comprises a set of nested quantiles that is generated by (i) generating a first set of quantiles for a time unit of the set of time units within the historical time period and (ii) aggregating the first set of quantiles into a second set of quantiles across the set of time units within the historical time period to generate the set of nested quantiles. The first set of quantiles may be associated with a smaller time unit (e.g., a time unit of the set of time units, such as a day) while the second set of quantiles may be associated with a larger time unit (e.g., the set of time units, such as a plurality days).

In some embodiments, a nested quantile describes a quantile that is a member of a set of quantiles. Nested quantiles may be generated at different levels of granularity within a dataset. For example, a first set of quantiles may be generated for each time unit (e.g., a day) of a set of time units (e.g., 90 days) comprising a historical time period. Each of the first set of quantiles (e.g., day-level quantiles) may be further aggregated into a second set of quantiles generated for the set of time units (e.g., historical time period-level quantiles). Alternatively, the second set of quantiles (historical time period-level quantiles) may be generated and then the first set of quantiles (day-level quantiles) may be generated within each quantile of the second set of quantiles. By generating nested quantiles at different time unit levels, both broad trends and finer-grained variations in data from a dataset may be emphasized for (multi-level) dataset filtering and/or analysis.

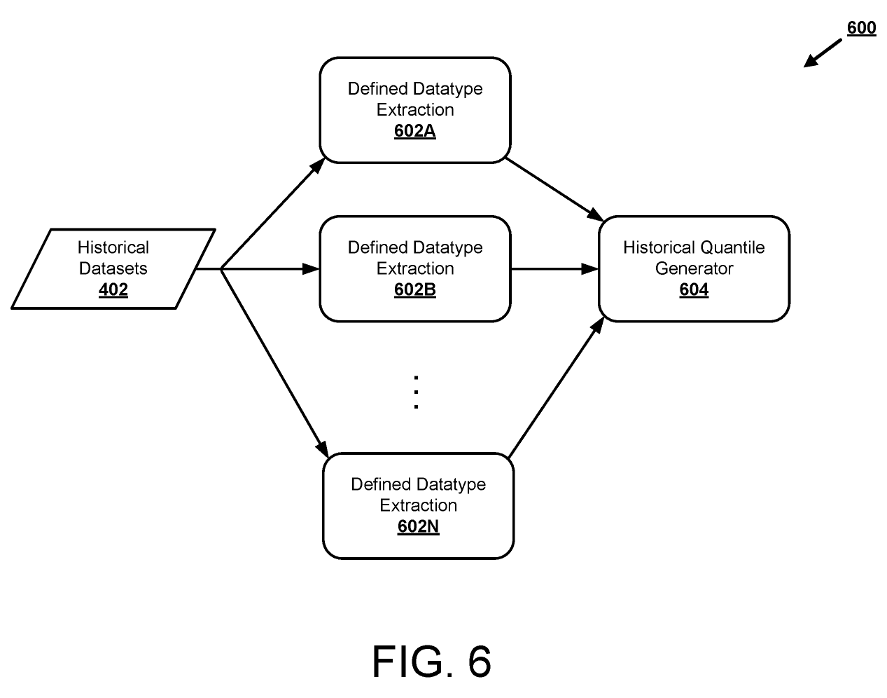

FIG. 6 depicts a dataflow diagram 600 of example hardware and/or software components for generating historical quantiles in accordance with some embodiments of the present disclosure. One or more historical datasets 402 are extracted via defined datatype extraction 602A, defined datatype extraction 602B, through defined datatype extraction 602N. As disclosed herewith, a historical quantile comprises a range of values that is associated with a filtering feature. In some embodiments, a filtering feature is associated with a defined datatype. As such, an adaptive data filtering subsystem (e.g., adaptive data filtering subsystem 406) may extract and/or assess defined datatypes from the one or more historical datasets 402. A historical quantile generator 604 may generate quantiles for the one or more historical datasets 402 based on the defined datatype extractions 602A through 602N. In this way, source-based filtering of data may be provided in an environment where the degree of informativeness of each data source providing data of specific defined datatypes may dynamically change in an unpredictable manner over time.

For example, historical quantiles are generated based on defined datatypes of filtering features of the one or more historical datasets 402. In some embodiments, a filtering feature (i) is associated with a defined datatype of a set of defined datatypes that respectively corresponds to the set of different data sources and (ii) comprises at least one of (a) a probabilistic value and corresponding to a probabilistic datatype, (b) a categorical value corresponding to defined categorical value range of a categorical datatype, or (c) a variable value corresponding to an undefined value range of a variable datatype. In some embodiments, responsive to the defined datatype comprising a variable datatype, the filtering feature is generated by normalizing, using a trained min-max scaler, a raw filtering feature.

In some embodiments, a defined datatype describes a datatype that comprises one or more specific characteristics. For example, a defined datatype may be specified by a formal definition of how a specific datatype should be interpreted, stored, and/or processed within a computer system. The definition of a datatype may comprise specifications for valid value ranges, formatting requirements, associated metadata, and/or custom data structures or classes. For example, data received from different data sources may be associated with specific defined datatypes. Accordingly, appropriate quantile generation, dataset filtering, and/or quality assessments may be performed on data from different data sources based on characteristics of each defined datatype. Thus, by identifying defined datatypes, data consistency and type-specific processing may be provided for dataset filtering. Data integrity checks and/or optimized processing of datasets may also be facilitated based on known characteristics of defined datatypes.

In some embodiments, a probabilistic datatype describes a type of data that comprises probability scores that are associated with a classification (e.g., generated by a machine learning model). For example, a probabilistic datatype may represent statistical or predictive information, in the form of numerical values between 0 and 1, indicating a likelihood and/or confidence level of a particular classification and/or outcome. A probabilistic datatype may also comprise metadata describing an associated classification or machine learning model that generated the classification. In some embodiments, a probabilistic datatype comprises a probability score generated by a machine learning model for a likelihood of a record containing valuable information or requiring further investigation.

In some embodiments, a categorical datatype describes a type of data that comprises category-specific data. That is, a categorical datatype may represent data comprising content that is associated with a specific category. Examples of specific categories may comprise, but are not limited to, government parameters, business parameters, and/or operational parameters. In some embodiments, a categorical datatype comprises data that is specific to a data source or type of data source. In some embodiments, a categorical datatype comprises data that is specific to a downstream process.

In some embodiments, a variable datatype describes a type of data that comprises a value that may vary over a wide range of values. For example, a variable datatype may represent data comprising a continuous or discrete range of unbounded values. In some embodiments, a variable datatype may be used to represent quantitative aspects of data that vary based on time or other factors. Examples of variable datatypes comprise, but are not limited to, transaction amounts, or quantity measures. In some embodiments, prior to generating quantiles for a dataset comprising a variable datatype, a min-max scaler is applied to data values of the dataset to handle high degrees of variability and to avoid skewed computations. A min-max scaler may comprise a machine learning model that is trained on historic data over a historical time period (e.g., a year) and by removing edge cases within the historical time period.

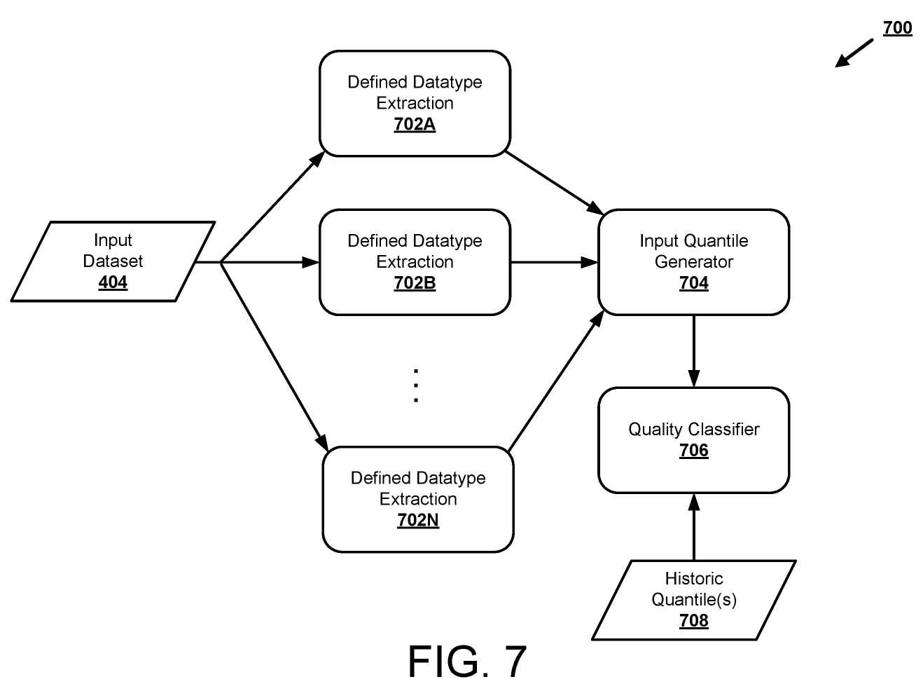

FIG. 7 depicts a dataflow diagram 700 of example hardware and/or software components for classifying input quantiles in accordance with some embodiments of the present disclosure. An input dataset 404 is extracted via defined datatype extraction 702A, defined datatype extraction 702B, through defined datatype extraction 702N. An input quantile generator 704 may generate input quantiles for the input dataset 404 based on the defined datatype extractions 702A through 702N. The input quantile generator 704 may provide input quantiles to quality classifier 706 to assess the quality of the input dataset 404 as compared to historical data. The quality classifier 706 may determine set-based similarity and/or difference scores (e.g., Jaccard index or Sørensen–Dice coefficient) between the input quantiles and one or more historic quantiles 708. As such, one or more of the historic quantiles 708 that most closely match (e.g., highest similarity score) the input quantiles may be determined (e.g., with a 10% tolerance) based on the similarity measure. Based on the matching, subsets of the input dataset 404 may be assigned to specific quality classes relative to the historic quantiles 708 (e.g., below normal, normal, above normal, or high). For example, higher feature values may be associated with higher quality classes. In this way, historical quantiles may be used to establish dynamic thresholds for data filtering, guide an adjustment of processing parameters, and/or inform downstream processes (e.g., machine learning models) about long-term data trends.

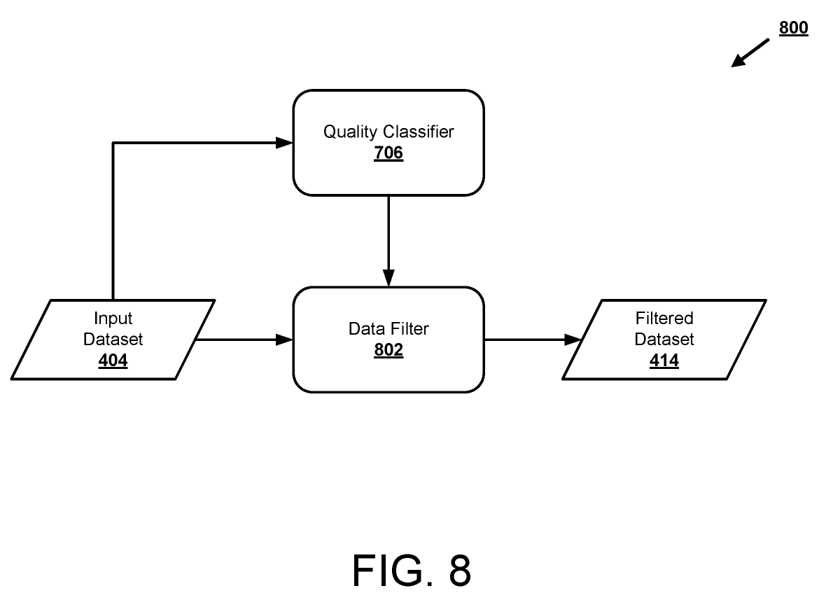

FIG. 8 depicts a dataflow diagram 800 of example hardware and/or software components for generating a filtered dataset in accordance with some embodiments of the present disclosure. Data filter 802 is configured to generate, based on quality classes assigned to subsets of the input dataset 404 by the quality classifier 706, a filtered dataset 414 from input dataset 404. The data filter 802 may generate the filtered dataset 414 using an iterative process to align the filtered dataset 414 based on quality and data volume parameters.

In some embodiments, data objects may be filtered from the input dataset 404 based on a quantile threshold that corresponds to a target quantile, wherein the target quantile may be associated with a specific level of data quality. Data objects of the input dataset 404 that are lower than the target quantile may be filtered out from the filtered dataset 414. For example, during an iteration, a target quantile associated with a “normal” data quality may be selected for filtering the input dataset 404.

In some embodiments, a dataset volume of the filtered dataset 414 is checked against a volume tolerance. The volume tolerance may be predefined to establish a guardrail for limiting a size of the filtered dataset 414. In some embodiments, a volume tolerance is associated with an operational parameter or a computational capacity. Volume tolerance may be inversely proportional to data quality. For example, a lower quantile threshold (e.g., poorer data quality) may be associated with a higher volume tolerance. If the filtered dataset 414 (e.g., filtered with an initial target quantile) is not within a volume tolerance, the data filter 802 may refine its filtering of the input dataset 404 on a data source and/or defined datatype basis. For example, the data filter 802 may compare (e.g., via similarity and/or difference scores) quality classes and associated data volumes across a plurality of data sources and/or defined datatypes. Based on the comparison, the data filter 802 may identify the sources of data and/or defined datatypes that are associated with the best quality (classes) of data. Additionally, or alternatively, the data filter 802 may identify the sources of data and/or defined datatypes that are associated with the poorest quality (classes) of data.

In some embodiments, the data filter 802 refilters the input dataset 404 by varying the quantile threshold based on the identification of the sources of data and/or defined datatypes that are associated with the best and/or worst quality of data. For example, if a data volume of the filtered dataset 414 is lower than the volume tolerance, the quantile threshold may be reduced for sources of data and/or defined datatypes that are associated with the best quality of data. If a data volume of the filtered dataset 414 is higher than the volume tolerance, the quantile threshold may be increased for sources of data and/or defined datatypes that are associated with the worst quality of data. Accordingly, a filtered dataset 414 may be iteratively regenerated to satisfy a desired volume tolerance by tuning the quantile threshold. A final filtered dataset 414 may be provided to downstream applications and processes. Additionally, to prevent an infinite loop of iterations, the data filter 802 may stop adjusting thresholds if data volume delta becomes marginal with each iteration.

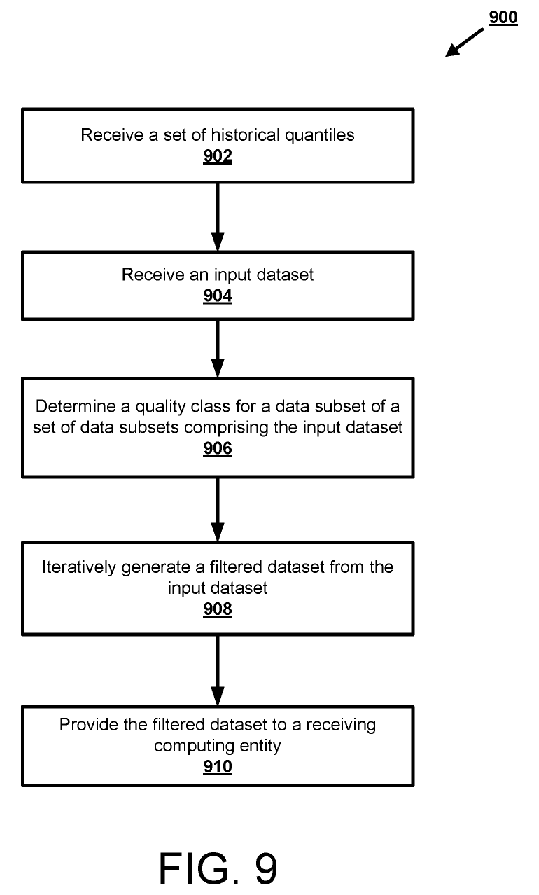

FIG. 9 depicts a flowchart diagram of an example data filtering process 900 in accordance with some embodiments of the present disclosure.

The flowchart diagram depicts an example data filtering process used to manage large volumes of incoming data from multiple sources while maintaining data quality and meeting operational (e.g., computing) constraints. The process 900 may be implemented by one or more computing devices, entities, and/or systems described herein. For example, via the various steps/operations of the process 900, the computing system 101 may match quantiles of input data with quantiles of historical data to assess the quality of data objects for filtering from the input data. By doing so, the process 900 improves computer functionality by improving data filtering that adapts to evolving data characteristics and operational parameters.

FIG. 9 illustrates an example process 900 for explanatory purposes. Although the example process 900 depicts a particular sequence of steps/operations, the sequence may be altered without departing from the scope of the present disclosure. For example, some of the steps/operations depicted may be performed in parallel or in a different sequence that does not materially impact the function of the process 900. In other examples, different components of an example device or system that implements the process 900 may perform functions at substantially the same time or in a specific sequence.

In some embodiments, the process 900 comprises, at operation 902, receiving a set of historical quantiles based on a set of historical datasets for a historical time period, wherein a historical quantile of the set of historical quantiles comprises a range of values that is associated with a filtering feature. For example, the computing system 101 may receive a set of historical quantiles based on a set of historical datasets for a historical time period, wherein a historical quantile of the set of historical quantiles comprises a range of values that is associated with a filtering feature.

In some embodiments, the process 900 comprises, at operation 904, receiving an input dataset for a new time period subsequent to the historical time period, wherein the input dataset comprises a set of data subsets respectively received from a set of different data sources. For example, the computing system 101 may receive an input dataset for a new time period subsequent to the historical time period, wherein the input dataset comprises a set of data subsets respectively received from a set of different data sources.

In some embodiments, the process 900 comprises, at operation 906, determining a quality class for a data subset of the set of data subsets based on (a) a set of input quantiles for the data subset and (b) the set of historical quantiles. For example, the computing system 101 may determine a quality class for a data subset of the set of data subsets based on (a) a set of input quantiles for the data subset and (b) the set of historical quantiles.

In some embodiments, the process 900 comprises, at operation 908, iteratively generating a filtered dataset from the input dataset. For example, the computing system 101 may iteratively generate a filtered dataset from the input dataset.

In some embodiments, the process 900 comprises, at operation 910, providing the filtered dataset to a receiving computing entity. For example, the computing system 101 may providing the filtered dataset to a receiving computing entity.

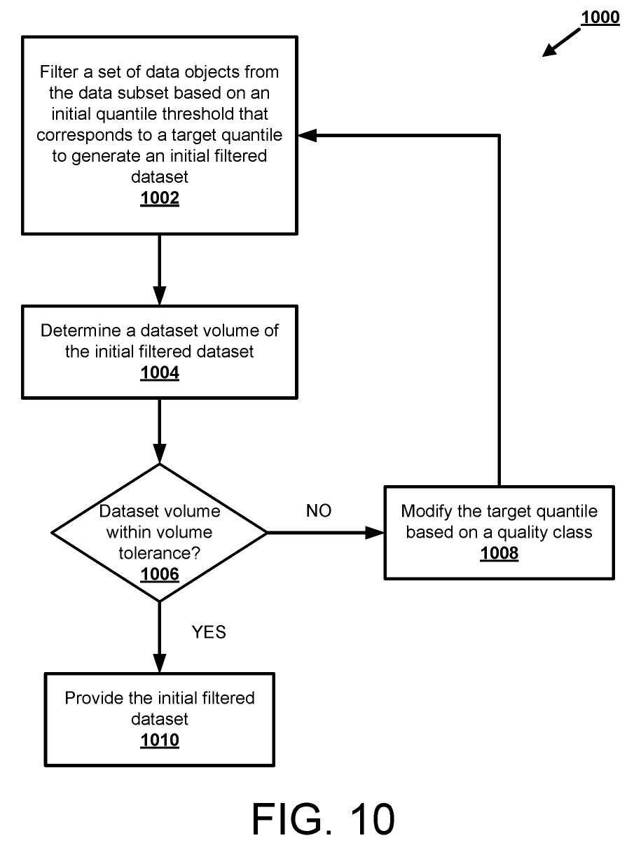

FIG. 10 depicts a flowchart diagram of an example filtered dataset generation process 1000 in accordance with some embodiments of the present disclosure.

The flowchart diagram depicts an example dynamic data filtering technique that optimizes data quality while maintaining data volume parameters. The process 1000 may be implemented by one or more computing devices, entities, and/or systems described herein. For example, via the various steps/operations of the process 1000, the computing system 101 may determine similarity and/or difference scores of input quantiles of new data with respect to historical quantiles such that data quality may be dynamically assessed and filtering thresholds may be adjusted accordingly. By doing so, the process 1000 improves computer functionality by optimizing computing resource allocation and ensuring downstream processes receive manageable volumes of high-quality data.

FIG. 10 illustrates an example process 1000 for explanatory purposes. Although the example process 1000 depicts a particular sequence of steps/operations, the sequence may be altered without departing from the scope of the present disclosure. For example, some of the steps/operations depicted may be performed in parallel or in a different sequence that does not materially impact the function of the process 1000. In other examples, different components of an example device or system that implements the process 1000 may perform functions at substantially the same time or in a specific sequence.

In some embodiments, the process 1000 comprises, at operation 1002, filtering a set of data objects from the data subset based on an initial quantile threshold that corresponds to a target quantile of the set of input quantiles to generate an initial filtered dataset. For example, the computing system 101 may filter a set of data objects from the data subset based on an initial quantile threshold that corresponds to a target quantile of the set of input quantiles to generate an initial filtered dataset.

In some embodiments, the process 1000 comprises, at operation 1004, determining a dataset volume of the initial filtered dataset. For example, the computing system 101 may determine a dataset volume of the initial filtered dataset.

In some embodiments, the process 1000 comprises, at operation 1006, determining whether the dataset volume is within a volume tolerance. For example, the computing system 101 may determine whether the dataset volume is within a volume tolerance.

In some embodiments, the process 1000 comprises, at operation 1008, responsive to the dataset volume failing to meet a volume tolerance, modifying the target quantile based on the quality class and refiltering the data subset. For example, the computing system 101 may, responsive to the dataset volume failing to meet a volume tolerance, modify the target quantile based on the quality class and refiltering the data subset.

In some embodiments, the process 1000 comprises, at operation 1010, providing the initial filtered dataset. For example, the computing system 101 may provide the initial filtered dataset.

### IV. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as comprising logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular datatypes. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model’s architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model’s architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model’s parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each operation may be performed by any one or combination of computing devices, entities, and/or systems described herein. For example, a computing system may comprise a single computing entity that is configured to perform all of the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising receiving, by one or more processors, a set of historical quantiles based on a set of historical datasets for a historical time period, wherein a historical quantile of the set of historical quantiles comprises a range of values that is associated with a filtering feature; receiving, by the one or more processors, an input dataset for a new time period subsequent to the historical time period, wherein the input dataset comprises a set of data subsets respectively received from a set of different data sources; determining, by the one or more processors, a quality class for a data subset of the set of data subsets based on (a) a set of input quantiles for the data subset and (b) the set of historical quantiles; iteratively generating, by the one or more processors, a filtered dataset from the input dataset by: filtering a set of data objects from the data subset based on an initial quantile threshold that corresponds to a target quantile of the set of input quantiles to generate an initial filtered dataset, determining a dataset volume of the initial filtered dataset, and responsive to the dataset volume failing to meet a volume tolerance, modifying the target quantile based on the quality class and refiltering the data subset; and providing, by the one or more processors, the filtered dataset to a receiving computing entity.

Example 2. The computer-implemented method of example 1, wherein modifying the target quantile comprises, in response to (i) the dataset volume exceeding the volume tolerance and (ii) the quality class exceeding a quality threshold, increasing the target quantile to a quantile subsequent to the initial quantile threshold.

Example 3. The computer-implemented method of example 1 wherein modifying the target quantile based on the quality class comprises, in response to (i) the dataset volume failing to meet the volume tolerance and (ii) the quality class failing to meet a quality threshold, decreasing the target quantile to a quantile preceding the initial quantile threshold.

Example 4. The computer-implemented method of example 1, wherein the input dataset is received, from the set of different data sources, at an intermediary messaging interface that is configured to (i) aggregate the set of data subsets into the input dataset and (ii) provide the filtered dataset to the receiving computing entity.

Example 5. The computer-implemented method of example 1, further comprising: storing the input dataset; and regenerating the set of historical quantiles based on the input dataset.

Example 6. The computer-implemented method of example 1, wherein the historical time period comprises a set of time units, and the set of historical quantiles comprises a set of nested quantiles that is generated by: generating a first set of quantiles for a time unit of the set of time units within the historical time period; and aggregating the first set of quantiles into a second set of quantiles across the set of time units within the historical time period to generate the set of nested quantiles.

Example 7. The computer-implemented method of example 1, wherein the filtering feature (i) is associated with a defined datatype of a set of defined datatypes that respectively corresponds to the set of different data sources and (ii) comprises at least one of (a) a probabilistic value and corresponding to a probabilistic datatype, (b) a categorical value corresponding to defined categorical value range of a categorical datatype, or (c) a variable value corresponding to an undefined value range of a variable datatype.

Example 8. The computer-implemented method of example 7, wherein the historical quantile is based on the defined datatype of the filtering feature.

Example 9. The computer-implemented method of example 7, wherein, responsive to the defined datatype comprising a variable datatype, the computer-implemented method further comprises generating the filtering feature by normalizing, using a trained min-max scaler, a raw filtering feature.

Example 10. The computer-implemented method of example 1, wherein the set of historical quantiles are divided into a set of quality classes and the quality class for the data subset is determined from the set of quality classes based on a matching historical quantile from the set of historical quantiles.

Example 11. A system comprising one or more processors and at least one memory storing processor-executable instructions that, when executed by any of the one or more processors, causes the one or more processors to perform operations comprising: receiving a set of historical quantiles based on a set of historical datasets for a historical time period, wherein a historical quantile of the set of historical quantiles comprises a range of values that is associated with a filtering feature; receiving an input dataset for a new time period subsequent to the historical time period, wherein the input dataset comprises a set of data subsets respectively received from a set of different data sources; determining a quality class for a data subset of the set of data subsets based on (a) a set of input quantiles for the data subset and (b) the set of historical quantiles; iteratively generating a filtered dataset from the input dataset by: filtering a set of data objects from the data subset based on an initial quantile threshold that corresponds to a target quantile of the set of input quantiles to generate an initial filtered dataset, determining a dataset volume of the initial filtered dataset, and responsive to the dataset volume failing to meet a volume tolerance, modifying the target quantile based on the quality class and refiltering the data subset; and providing the filtered dataset to a receiving computing entity.

Example 12. The system of example 11, wherein to modify the target quantile, the operations further comprise, in response to (i) the dataset volume exceeding the volume tolerance and (ii) the quality class exceeding a quality threshold, increasing the target quantile to a quantile subsequent to the initial quantile threshold.

Example 13. The system of example 11, wherein to modify the target quantile based on the quality class, the operations further comprise, in response to (i) the dataset volume failing to meet the volume tolerance and (ii) the quality class failing to meet a quality threshold, decreasing the target quantile to a quantile preceding the initial quantile threshold.

Example 14. The system of example 11, wherein the input dataset is received, from the set of different data sources, at an intermediary messaging interface that is configured to (i) aggregate the set of data subsets into the input dataset and (ii) provide the filtered dataset to the receiving computing entity.

Example 15. The system of example 11, wherein the historical time period comprises a set of time units, and the set of historical quantiles comprises a set of nested quantiles that is generated by: generating a first set of quantiles for a time unit of the set of time units within the historical time period; and aggregating the first set of quantiles into a second set of quantiles across the set of time units within the historical time period to generate the set of nested quantiles.

Example 16. The system of example 11, wherein the filtering feature (i) is associated with a defined datatype of a set of defined datatypes that respectively corresponds to the set of different data sources and (ii) comprises at least one of (a) a probabilistic value and corresponding to a probabilistic datatype, (b) a categorical value corresponding to defined categorical value range of a categorical datatype, or (c) a variable value corresponding to an undefined value range of a variable datatype.

Example 17. The system of example 11, wherein the set of historical quantiles are divided into a set of quality classes and the quality class for the data subset is determined from the set of quality classes based on a matching historical quantile from the set of historical quantiles.

Example 18. One or more non-transitory computer-readable storage media including instructions that, when executed by one or more processors, cause the one or more processors to perform operations comprising receiving a set of historical quantiles based on a set of historical datasets for a historical time period, wherein a historical quantile of the set of historical quantiles comprises a range of values that is associated with a filtering feature; receiving an input dataset for a new time period subsequent to the historical time period, wherein the input dataset comprises a set of data subsets respectively received from a set of different data sources; determining a quality class for a data subset of the set of data subsets based on (a) a set of input quantiles for the data subset and (b) the set of historical quantiles; iteratively generating a filtered dataset from the input dataset by: filtering a set of data objects from the data subset based on an initial quantile threshold that corresponds to a target quantile of the set of input quantiles to generate an initial filtered dataset, determining a dataset volume of the initial filtered dataset, and responsive to the dataset volume failing to meet a volume tolerance, modifying the target quantile based on the quality class and refiltering the data subset; and providing the filtered dataset to a receiving computing entity.

Example 19. The one or more non-transitory computer-readable storage media of example 18, wherein the filtering feature (i) is associated with a defined datatype of a set of defined datatypes that respectively corresponds to the set of different data sources and (ii) comprises at least one of (a) a probabilistic value and corresponding to a probabilistic datatype, (b) a categorical value corresponding to defined categorical value range of a categorical datatype, or (c) a variable value corresponding to an undefined value range of a variable datatype.

Example 20. The one or more non-transitory computer-readable storage media of example 18, wherein the set of historical quantiles are divided into a set of quality classes and the quality class for the data subset is determined from the set of quality classes based on a matching historical quantile from the set of historical quantiles.

What is claimed is:

1. A computer-implemented method comprising:
receiving, by one or more processors, a set of historical quantiles based on a set of historical datasets for a historical time period, wherein a historical quantile of the set of historical quantiles comprises a range of values that is associated with a filtering feature;
receiving, by the one or more processors, an input dataset for a new time period subsequent to the historical time period, wherein the input dataset comprises a set of data subsets respectively received from a set of different data sources;
determining, by the one or more processors, a quality class for a data subset of the set of data subsets based on (a) a set of input quantiles for the data subset and (b) the set of historical quantiles;
iteratively generating, by the one or more processors, a filtered dataset from the input dataset by:
filtering a set of data objects from the data subset based on an initial quantile threshold that corresponds to a target quantile of the set of input quantiles to generate an initial filtered dataset,
determining a dataset volume of the initial filtered dataset, and
responsive to the dataset volume failing to meet a volume tolerance, modifying the target quantile based on the quality class and refiltering the data subset; and
providing, by the one or more processors, the filtered dataset to a receiving computing entity.

2. The computer-implemented method of claim 1, wherein modifying the target quantile comprises, in response to (i) the dataset volume exceeding the volume tolerance and (ii) the quality class exceeding a quality threshold, increasing the target quantile to a quantile subsequent to the initial quantile threshold.

3. The computer-implemented method of claim 1 wherein modifying the target quantile based on the quality class comprises, in response to (i) the dataset volume failing to meet the volume tolerance and (ii) the quality class failing to meet a quality threshold, decreasing the target quantile to a quantile preceding the initial quantile threshold.

4. The computer-implemented method of claim 1, wherein the input dataset is received, from the set of different data sources, at an intermediary messaging interface that is configured to (i) aggregate the set of data subsets into the input dataset and (ii) provide the filtered dataset to the receiving computing entity.

5. The computer-implemented method of claim 1, further comprising:
storing the input dataset; and
regenerating the set of historical quantiles based on the input dataset.

6. The computer-implemented method of claim 1, wherein the historical time period comprises a set of time units, and the set of historical quantiles comprises a set of nested quantiles that is generated by:
generating a first set of quantiles for a time unit of the set of time units within the historical time period; and
aggregating the first set of quantiles into a second set of quantiles across the set of time units within the historical time period to generate the set of nested quantiles.

7. The computer-implemented method of claim 1, wherein the filtering feature (i) is associated with a defined datatype of a set of defined datatypes that respectively corresponds to the set of different data sources and (ii) comprises at least one of (a) a probabilistic value and corresponding to a probabilistic datatype, (b) a categorical value corresponding to defined categorical value range of a categorical datatype, or (c) a variable value corresponding to an undefined value range of a variable datatype.

8. The computer-implemented method of claim 7, wherein the historical quantile is based on the defined datatype of the filtering feature.

9. The computer-implemented method of claim 7, wherein, responsive to the defined datatype comprising a variable datatype, the computer-implemented method further comprises generating the filtering feature by normalizing, using a trained min-max scaler, a raw filtering feature.

10. The computer-implemented method of claim 1, wherein the set of historical quantiles are divided into a set of quality classes and the quality class for the data subset is determined from the set of quality classes based on a matching historical quantile from the set of historical quantiles.

11. A system comprising
one or more processors and
at least one memory storing processor-executable instructions that, when executed by any of the one or more processors, causes the one or more processors to perform operations comprising:
receiving a set of historical quantiles based on a set of historical datasets for a historical time period, wherein a historical quantile of the set of historical quantiles comprises a range of values that is associated with a filtering feature;
receiving an input dataset for a new time period subsequent to the historical time period, wherein the input dataset comprises a set of data subsets respectively received from a set of different data sources;
determining a quality class for a data subset of the set of data subsets based on (a) a set of input quantiles for the data subset and (b) the set of historical quantiles;
iteratively generating a filtered dataset from the input dataset by:
filtering a set of data objects from the data subset based on an initial quantile threshold that corresponds to a target quantile of the set of input quantiles to generate an initial filtered dataset,
determining a dataset volume of the initial filtered dataset, and
responsive to the dataset volume failing to meet a volume tolerance, modifying the target quantile based on the quality class and refiltering the data subset; and
providing the filtered dataset to a receiving computing entity.

12. The system of claim 11, wherein to modify the target quantile, the operations further comprise, in response to (i) the dataset volume exceeding the volume tolerance and (ii) the quality class exceeding a quality threshold, increasing the target quantile to a quantile subsequent to the initial quantile threshold.

13. The system of claim 11, wherein to modify the target quantile based on the quality class, the operations further comprise, in response to (i) the dataset volume failing to meet the volume tolerance and (ii) the quality class failing to meet a quality threshold, decreasing the target quantile to a quantile preceding the initial quantile threshold.

14. The system of claim 11, wherein the input dataset is received, from the set of different data sources, at an intermediary messaging interface that is configured to (i) aggregate the set of data subsets into the input dataset and (ii) provide the filtered dataset to the receiving computing entity.

15. The system of claim 11, wherein the historical time period comprises a set of time units, and the set of historical quantiles comprises a set of nested quantiles that is generated by:
generating a first set of quantiles for a time unit of the set of time units within the historical time period; and
aggregating the first set of quantiles into a second set of quantiles across the set of time units within the historical time period to generate the set of nested quantiles.

16. The system of claim 11, wherein the filtering feature (i) is associated with a defined datatype of a set of defined datatypes that respectively corresponds to the set of different data sources and (ii) comprises at least one of (a) a probabilistic value and corresponding to a probabilistic datatype, (b) a categorical value corresponding to defined categorical value range of a categorical datatype, or (c) a variable value corresponding to an undefined value range of a variable datatype.

17. The system of claim 11, wherein the set of historical quantiles are divided into a set of quality classes and the quality class for the data subset is determined from the set of quality classes based on a matching historical quantile from the set of historical quantiles.

18. One or more non-transitory computer-readable storage media including instructions that, when executed by one or more processors, cause the one or more processors to perform operations comprising:
receiving a set of historical quantiles based on a set of historical datasets for a historical time period, wherein a historical quantile of the set of historical quantiles comprises a range of values that is associated with a filtering feature;
receiving an input dataset for a new time period subsequent to the historical time period, wherein the input dataset comprises a set of data subsets respectively received from a set of different data sources;
determining a quality class for a data subset of the set of data subsets based on (a) a set of input quantiles for the data subset and (b) the set of historical quantiles;
iteratively generating a filtered dataset from the input dataset by:
filtering a set of data objects from the data subset based on an initial quantile threshold that corresponds to a target quantile of the set of input quantiles to generate an initial filtered dataset,
determining a dataset volume of the initial filtered dataset, and
responsive to the dataset volume failing to meet a volume tolerance, modifying the target quantile based on the quality class and refiltering the data subset; and
providing the filtered dataset to a receiving computing entity.

19. The one or more non-transitory computer-readable storage media of claim 18, wherein the filtering feature (i) is associated with a defined datatype of a set of defined datatypes that respectively corresponds to the set of different data sources and (ii) comprises at least one of (a) a probabilistic value and corresponding to a probabilistic datatype, (b) a categorical value corresponding to defined categorical value range of a categorical datatype, or (c) a variable value corresponding to an undefined value range of a variable datatype.

20. The one or more non-transitory computer-readable storage media of claim 18, wherein the set of historical quantiles are divided into a set of quality classes and the quality class for the data subset is determined from the set of quality classes based on a matching historical quantile from the set of historical quantiles.
